(19) United States
(12) Patent Application Publication
(10) Pub. No.: US 2005/0128437 A1
(43) Pub. Date: Jun. 16, 2005

(54) System and method for positioning projectors in space to steer projections and afford interaction

(75) Inventors: Gopal Pingali, Mohegan Lake, NY (US); Claudio Pinhanez, New York, NY (US); Mark Edward Podlaseck, New Preston, CT (US); Anthony Levas, Yorktown Heights, NY (US); Frederik C.M. Kjeldsen, Poughkeepsie, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/735,053

(22) Filed: Dec. 12, 2003

(51) Int. Cl. G03B 21/14

(52) U.S. Cl. 353/69

(57) ABSTRACT

A positioning system for locating at least one interactive projection unit, and methods for operation thereof is disclosed. The positioning system includes equipment for providing multiple degrees of freedom for locating the at least one projection unit. The at least one projection unit is equipped with various components and capabilities to provide for projection onto surfaces within a variety of settings, and thus provide for display, information, interaction and computing in the variety of settings.

### TECHNICAL FIELD OF THE INVENTION

This invention relates to positioning systems for interactive display devices useful in retail, manufacturing, and other such settings.

### BACKGROUND OF THE INVENTION

A concept having growing popularity is that of ubiquitous computing. Certain technologies have been developed, or are presently in development, to further provide for ubiquitous computing. Some examples of such systems are presented in the publication by Claudio Pinhanez, entitled “The Everywhere Displays Projector: A Device to Create Ubiquitous Graphical Interfaces,” appearing in the Proceedings of Ubiquitous Computing 2001 (Ubicomp”01), Atlanta, Ga., September 2001; a publication by Gopal Pingali, Claudio Pinhanez, Anthony Levas, Rick Kjeldsen, Mark Podlaseck, Han Chen, Noi Sukaviriya, Mark Weiser, entitled “Steerable Interfaces for Pervasive Computing Spaces,” appearing in the proceedings of the IEEE International Conference on Pervasive Computing and Communications—PerCom'03. Dallas Fort Worth, Tex., March 2003; and, U.S. Pat. No. 6,431,711, entitled “Multiple-Surface Display Projector with Interactive Input Capability,” and issued to Claudio Pinhanez on Aug. 13, 2002.

In U.S. Pat. No. 6,431,711, Pinhanez discloses a system for projecting an image onto a surface in a room while distorting the image before projection so that a projected version of the image will not be distorted. The image may be displayed at multiple locations along a surface or multiple surfaces, and may move from one location to another location. The projected image remains undistorted through the move. Interaction between individuals and a projector is described. Interactive input may include use of devices such as hyperlinks included in the projected image. Other components, such as a camera, may be incorporated to provide for interactive operation. One example of a system intended to produce high quality images is the DL1 available from High End Systems, of Austin Tex. Although this system is designed for projecting an image onto a surface in a room, this system is not equipped for interaction.

The projection system of Pinhanez is shown as a fixed system in a single location, where the projection image may be re-directed using a mirror. The mirror provides steering about two degrees of freedom (pan and tilt). Since the projection and vision system bases are fixed, the physical space that can be effectively projected upon is limited by the position and capabilities of hardware included in the system.

Other examples of interface systems are disclosed in the publication by Noi Sukaviriya, Mark Podlaseck, Rick Kjeldsen, Anthony Levas, Gopal Pingali, Claudio Pinhanez, entitled “Embedding Interactions in a Retail Store Environment: The Design and Lessons Learned,” appearing in the proceedings of the Ninth IFIP International Conference on Human-Computer Interaction (INTERACT'03), Zurich, Switzerland. September 2003; and, a publication by Anthony Levas, Claudio Pinhanez, Gopal Pingali, Rick Kjeldsen, Mark Podlaseck, Noi Sukaviriya, entitled “An Architecture and Framework for Steerable Interface Systems,” appearing in the proceedings of the Fifth International conference on Ubiquitous Computing, Oct. 12-16, 2003.

FIG. 1 illustrates a mounting system (prior art) for a display projector, such as one described in the foregoing publications. In FIG. 1, the projector is rotated to achieve pan motion (in the X, Y plane). Similarly, FIG. 2 illustrates the tilt axis motion of the projector (also prior art). In either embodiment, the projection can be directed to any surface that is in the “line of sight” of the projector. These mounting systems are considered to be substantially similar to the system in U.S. Pat. No. 6,431,711. That is, images are projected on surfaces that are in the “line of sight” of the redirected projection, which is achieved by pan and tilt control of a mirror system.

One problem that is inherent in the “line of sight” projector is occlusion. That is, if a user is in some way blocking the projection, the user cannot see what is being projected and cannot interact with the occluded region. This type of problem is depicted in FIG. 3 (prior art), where a portion of surface 1 is occluded by a person D. Due to the fixed base of this mounting system, the projector is generally limited in the surfaces that can be reached.

Further, when existing projector technology is implemented in a setting that is geographically large in comparison to the projection area, it is advantageous to employ multiple projectors. This has the advantage of providing service coverage. However, such implementations can be excessively expensive. For example, many projectors may be required while some portions of the setting may experience limited use. Therefore utilization of devices may be quite variable based on location. For example, as present projectors serve only one request a time, fixed equipment used in high traffic areas may become bottlenecked with traffic, and cause user wait time. This may be detrimental to user acceptance of the technology by frustrating users who wait in line and stand witness to nearby equipment sitting idle.

Projectors for interactive computing may be useful in a variety of environments. However, due to limitations in existing designs for mounting systems, such systems may have limited availability, and be unnecessarily expensive. The variety of applications for present systems is therefore limited by the present mounting systems. What is needed is an enhanced mounting system for a projector such as one that may be used in a broad range of applications.

### SUMMARY OF THE INVENTION

The foregoing and other problems are overcome by methods and apparatus in accordance with embodiments of this invention.

Disclosed herein is a positioning system that includes at least one mount for mounting a projection unit, the projection unit having at least a projector for projecting a distorted image; wherein the at least one mount is coupled to a mechanism for providing rotational movement and translational movement for adjusting one of a position and an orientation of the projection unit to produce from the distorted image a substantially undistorted image on a surface.

Also disclosed is a method for providing a substantially undistorted image upon a surface, that includes: sensing a request from a user for a projection at a location; selecting a projection unit having at least a projector for projecting a distorted image; and, moving the at least one projector by operating a mechanism having the at least one projector mounted on a moveable portion thereof, wherein the mechanism is adapted for providing rotational movement and translational movement of the at least one projector to provide the substantially undistorted image upon the surface at the location.

Further disclosed is a method for calibrating a positioning system for a projection unit comprised of at least a projector adapted for projecting a distorted image, the positioning system for providing a substantially undistorted image to a user, that includes: loading a calibration image into the at least one projector; moving the at least one projector at a location to project the calibration image upon a target surface; adjusting settings of the at least one projector to produce a calibration image that is substantially undistorted upon the target surface; recording the settings for the at least one projector at the location; associating the settings with the target surface to produce a set of geometric model data; storing the set of geometric model data; and, repeating the loading, moving, adjusting, recording, associating and storing for a plurality of positions of the at least one projector.

Also disclosed is a method to provide a substantially undistorted image upon a surface at a location, that includes: selecting a projection unit coupled to a positioning system, the projection unit comprised of at least a projector for providing a distorted image coupled to a redirection device for redirecting the distorted image; loading setting layout information into a positioning controller for operating the positioning system; positioning the at least one projector at a location by referring to the setting layout information; referring to the setting layout information to determine projection settings for the at least one projector; and, adjusting the settings of the at least one projector to the projection settings to produce the substantially undistorted image upon the surface at the location.

Further disclosed is a method for adjusting at least one input setting of an interaction recognition system coupled to a positioning system, that includes: selecting a positioning system having at least one mount adapted for mounting a projection unit and at least another mount for positioning the interaction recognition system mounted thereto, the projection unit having at least a projector for projecting a distorted image; wherein the at least one mount is coupled to a mechanism providing rotational movement and translational movement for adjusting a position of the at least one mount and adapted for producing from the distorted image a substantially undistorted image on a surface; loading area layout information into a positioning controller for operating the positioning system; positioning the interaction recognition system at a location by referring to the area layout information; referring to the area layout information to optimize the at least one input setting for the interaction recognition system; and, adjusting the at least one input setting of the interaction recognition system.

Also disclosed is a computer program stored on a computer readable media, the program providing instructions for positioning a projection unit to produce a substantially undistorted image, the instructions for: sensing a request from a user for production of an image; determining a location of the request; selecting a surface from multiple surfaces for providing the image at the location; and, positioning the projection unit to provide the substantially undistorted image upon the surface.

Also disclosed is a positioning system, that has at least a mounting means for mounting a projection means having at least an image projecting means for projecting a distorted image; wherein the at least one mounting means is coupled to a positioning means for providing rotational movement and translational movement of the projection means to produce a substantially undistorted image from the distorted image.

Further still, a projection system, is disclosed that includes: at least one projection unit having at least a projector for projecting a distorted image, the at least one projector mounted to at least one mount; wherein the at least one mount is coupled to a mechanism providing rotational movement and translational movement for adjusting a position of the at least one projector to produce a substantially undistorted image from the distorted image.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 illustrates the pan motion of an existing mounting system for a projector;

FIG. 2 illustrates the tilt motion of an existing mounting system for a projector;

FIG. 3 depicts a projector having an existing type of mounting system, and illustrates how an individual can occlude a projection;

FIG. 4 depicts aspects of a projection system using an embodiment of a mounting system as disclosed herein;

FIG. 5 depicts one embodiment of a display projector system implementing the mounting system disclosed herein;

FIG. 6 depicts an example of improvements to projector positioning;

FIG. 7 depicts an exemplary setting for operation of the enhanced projection system;

FIG. 8 depicts a second embodiment of the positioning system where multiple projectors are used;

FIG. 9 depicts a third embodiment of the positioning system where multiple projectors are used;

FIG. 10 presents a flow chart which relates components of the projection system for one embodiment;

FIG. 11 presents a flow chart depicting operation of the system for one embodiment; and,

FIG. 12 depicts one embodiment of a calibration sequence for the positioning system.

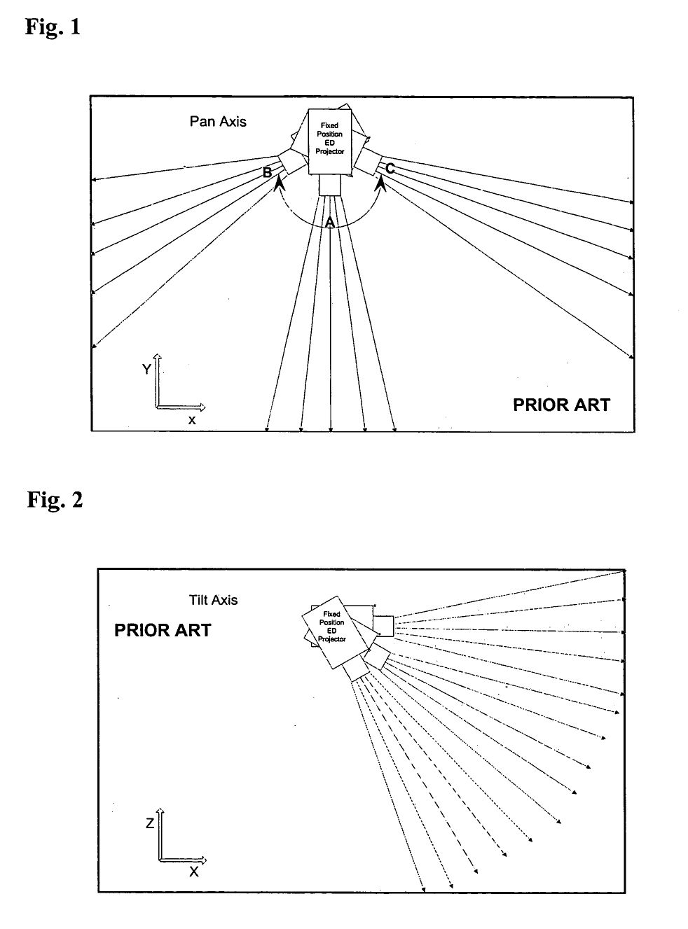

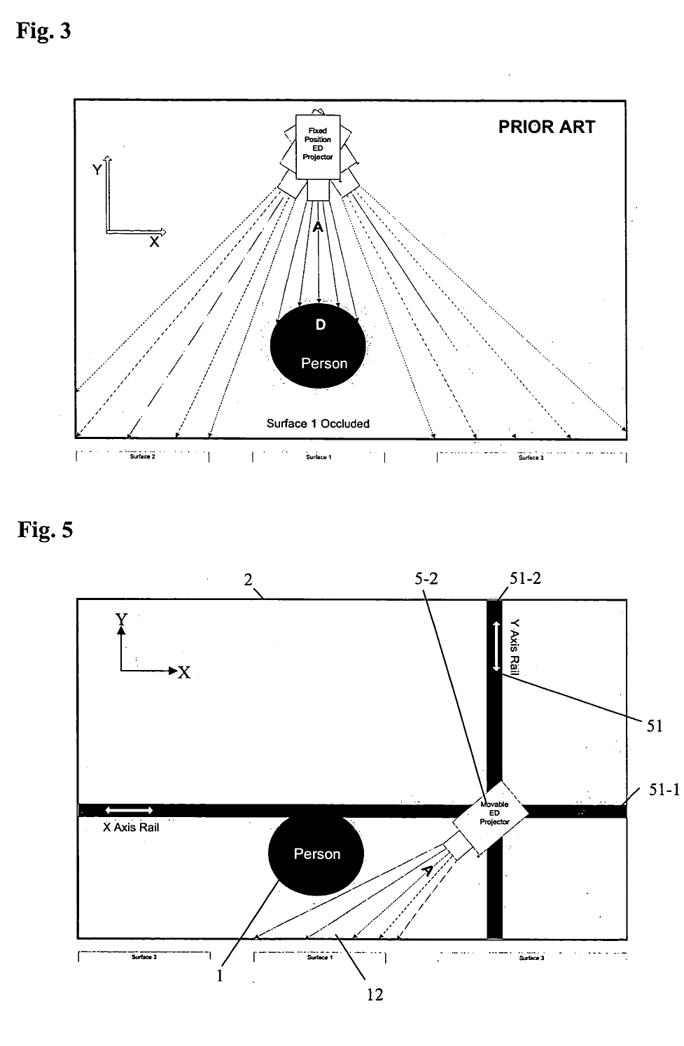

### DETAILED DESCRIPTION OF THE INVENTION

Disclosed herein are methods and apparatus for positioning and controlling a projection unit. The projection unit is suited for use in retail outlets, manufacturing environments, office environments, planning meetings, and other settings. Typically, the projection unit provides for display of images on surfaces that are a part of the setting (e.g., a wall). The projection unit may include an interactive component for user input. Aspects of the projection unit are described in U.S. Pat. No. 6,431,711, entitled “Multiple-Surface Display Projector with Interactive Input Capability,” issued to Pinhanez on Aug. 13, 2002. The disclosure of U.S. Pat. No. 6,431,711 is incorporated by reference herein in its entirety.

The projection system discussed herein generally includes a positioning system for providing a variety of positions and orientations for a projection unit. The projection unit is mounted on the positioning system, typically by use of a mount. In one embodiment, both the positioning system and the projection unit are equipped to provide the projection unit with movement through two or more degrees of freedom. For example, in one embodiment, the positioning system provides translational movement through three degrees of freedom (i.e., movement along the X, Y, Z axes). The positioning system also includes equipment for providing rotational movement through an additional three degrees of freedom (i.e., movement about the X, Y, Z axes). Non-limiting examples of equipment for providing rotational freedom of movement include equipment for providing pan, tilt and roll functions. In some non-limiting embodiments, the pan, tilt and roll functions are inherent to the projection unit. The translational and rotational movement provided by the positioning system provides for a variety of configurations in the positioning (translation) and orientation (rotation) of the projection unit, thus the positioning of a projected image in space. The variety of configurations provides for the projection of substantially undistorted images on various surfaces. One skilled in the art will recognize that a variety of combinations may be realized.

As discussed herein, a positioning system includes a positioning mechanism (or “positioning equipment”) to provide for flexibility in positioning of the projection unit. Redirection equipment may be included with the projection unit to provide flexibility in the positioning of an image produced by the projection unit. Examples of redirection equipment include a mirror, and/or other apparatus such as such as optical fiber, a prism and at least one lens.

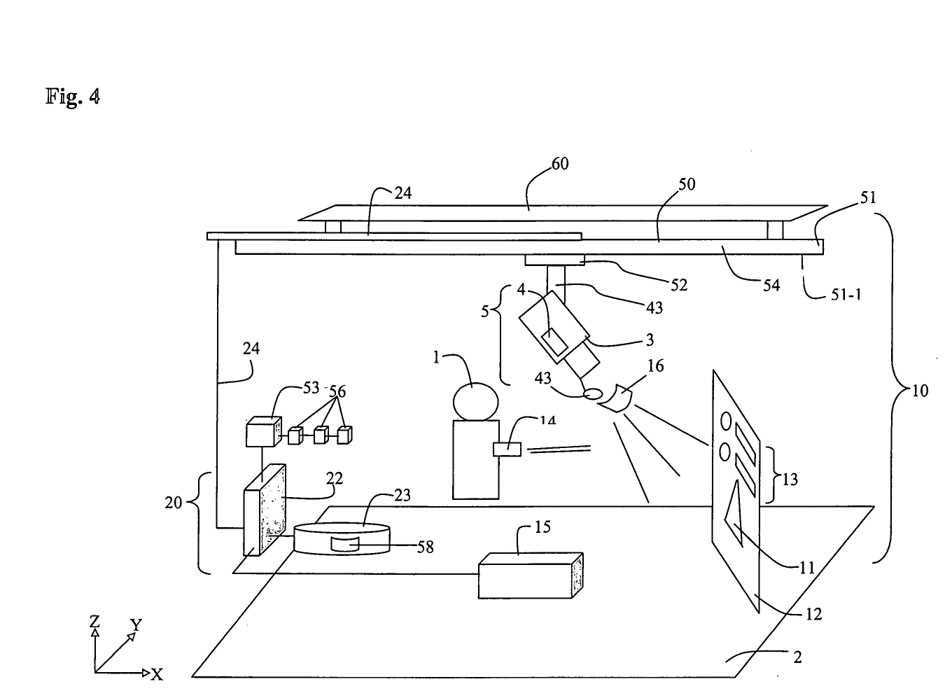

FIG. 4 depicts one embodiment of the projection system 10. In the setting 2 depicted in FIG. 4, the projection system 10 includes a projection unit 5. Preferably, the projection unit 5 includes a redirection device 43. In the embodiment depicted the redirection device 43 includes a mirror.

The projection system 10 is preferably equipped with an interaction recognition system 4 for providing interactive capabilities. One example of the interaction recognition system 4 suited for providing interactive capabilities is a camera which is coupled to the projection system 10. The interaction recognition system 4 may include equipment other than (or in addition to) the camera. For example, wireless communication systems may be used to receive a system input from the user 1. A voice recognition system may be included, and be equipped with at least a microphone. In some embodiments, the interaction recognition system 4 is mounted on the positioning system 50 independent of the projection unit 5. In these embodiments, the positioning system 50 is typically operated so as to control an aspect of the interaction recognition system 4, such as the field of view, or other aspects of the camera. In some embodiments, the interaction recognition system 4 also includes the redirection device 43.

For convenience, it is generally considered that the projection unit 5 includes the projector 3 and a display controller 20. The display controller 20 provides for generation of a distorted image 16. The distorted image 16 is provided to the projector 3 for projection. The display controller 20 may be integrated with the projector 3, such as within the housing of the projector 3, mounted with the projection unit 5, or the display controller 20 may be remote from the projector 3 (as depicted in FIG. 4). The projection unit 5 may further be integrated with the interaction recognition system 4. Alternatively, the interaction recognition system 4 may be separate from the projection unit 5.

Preferably, the projection unit 5 is mounted upon the positioning system 50 by use of a mount 52. In the example provided in FIG. 4, the projection unit 5 is mounted upon a mount 52 which is a carriage. The mount 52 is coupled to a positioning mechanism 54. In the embodiment depicted, the positioning mechanism 54 includes a rail system 51. The rail system 51 is preferably attached to a fixed support 60 (e.g., a ceiling). Preferably, the positioning mechanism 54 establishes firm placement and reproducible positioning of at least the projector 3. The mount 52 may include additional equipment (i.e., electromechanical components) to provide for movement in combination with the positioning mechanism 54, such as along the length of the rail 51-1 of the rail system 51. Preferably, movement is initiated upon receipt of remote commands. Preferably, the mount 52 includes a device, such as a gimbal, which is coupled to the projection unit 5. In preferred embodiments, the positioning system 50 provides for automated operation by use of automation components, such as electro-mechanical components in at least one of the positioning mechanism 54, the mount 52, and the redirection device 43 in combination with a positioning controller 53.

Typically, the projection unit 5 communicates with a display controller 20 via communications equipment 24. One example of suitable communications equipment 24 includes a local area network (LAN). Typically, the display controller 20 includes a processor 22, and storage device 23. Exemplary equipment for the display controller 20 includes a personal computer equipped with a hard drive. Other non-limiting forms of storage devices 23 include optical media, magnetic media and semiconductor devices, and may further include combinations of the foregoing. Preferably, the display controller 20 obtains an original copy of an image, and provides information for the generation of the distorted image 16. In some embodiments, the display controller 20 is remotely coupled to the projection unit 5, as is depicted in FIG. 4. In other embodiments, the display controller 20 is integrated into the projection unit 5.

It is not required that the projection unit 5 has the camera, or other complimentary equipment. Rather, it is preferred that the projection unit 5 be equipped to produce the distorted image 16. Preferably, the distorted image 11 is distorted (“pre-warped” or otherwise adjusted) to appear with adequate quality substantially undistorted on surfaces 12, such as those positioned at oblique angles from the projection unit 5. Preferably, the positioning system 50 is configured so as to steer the distorted image 16 to provide appropriate quality adjustments which produce the substantially undistorted image 11.

In general, the projector 3 produces a distorted image 16 that has a particular aspect ratio. By “substantially undistorted” it is meant, for certain types of projectors 3, that the projection is a substantially undistorted image 11 at the projection surface 12. Preferably, the substantially undistorted image 11 preserves the same proportion of width to length of the original copy of the image (and is therefore considered an “undistorted image”). For example, for an original copy of a rectangular image, the proportion of width to length is preserved, as well as the 90 degree angles of the original rectangular image. For some projectors 3 (such as those used for producing a round image 16), “substantially undistorted” means that the displayed substantially undistorted image 11 will retain the same approximate proportions and angles as the original copy of the image. An image that is “undistorted,” “distortionless,” “distortion-free” or “substantially undistorted” may also be taken to mean an image of satisfactory quality.

Projection may be performed upon a variety of surfaces 12. One non-limiting example of the projection surface 12 is a wall. The substantially undistorted image 11 typically includes an interactive region 13. The user 1 may interact with the projection system 10 by use of an input device 14. Non-limiting examples of input devices 14 include laser pointers, wireless devices and hand gestures. Input received from the user 1 may be analyzed by the display controller 20, and used as instructions for operation of external equipment 15. External equipment 15 may include any equipment considered appropriate (to the setting 2, or as is otherwise considered appropriate) such as a computer or process control equipment.

Preferably, the positioning system 50 includes the positioning controller 53 to provide for integrating operation of the display controller 20 with the movements of the projection unit 5. In one embodiment, the positioning controller 53 accepts input from tracking and sensing equipment 56 to ensure appropriate movement of the projection unit 5. Tracking and sensing equipment 56 may include a variety of devices, such as sensors, tracking devices, wireless communications systems, RFID systems and others. In other embodiments, the positioning controller 53 and the display controller 20 are merged, and one controller is used. Tracking and sensing equipment 56 may be used to identify occlusions in a projection area, and to provide input to the positioning controller 53 to ensure avoidance of the occlusion. In some embodiments, the tracking and sensing equipment 56 operate to automatically identify a request from a user 1. In other embodiments, the tracking and sensing equipment 56 operate to identify a request from a user 1 upon a manual input. In further embodiments, combinations of automatic and manual inputs provide for aspects of the request for interaction.

For convenience, it is considered that a setting 2 includes an area, such as, in non-limiting examples, a room, a hall, an exterior wall, or any similar environment which has at least one surface 12 suitable for hosting an image 11. It should be noted that the term “setting” is not taken to mean a surface alone, and generally includes an area for generating, hosting and using the substantially undistorted image 11.

FIG. 5 illustrates aspects of another embodiment of the projection unit 5 mounted on the positioning system 50. In FIG. 5, the positioning system 50 includes a rail system 51 that has two degrees of freedom. The rail system 51 provides for translational movement in an X and Y plane, as well as preserving roll, pan and tilt rotational motion of the projection unit 5. In this embodiment, the positioning system 50 can be repositioned through computer control to project onto the projection surface 12 that was previously occluded by a person in the projection area.

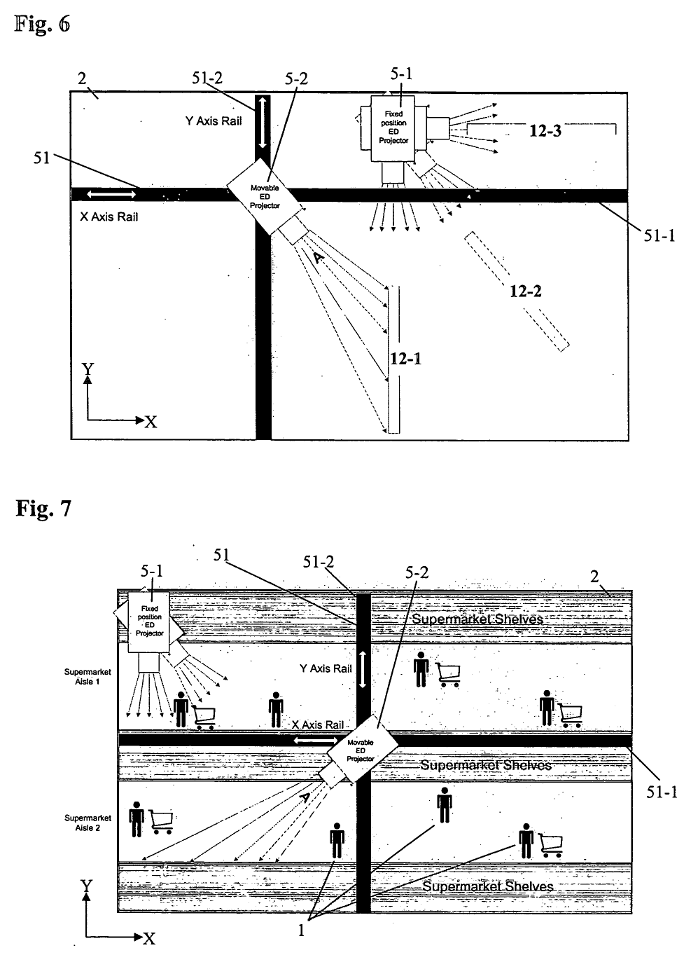

FIG. 6 further illustrates the capability to reach projection surfaces 12 that would normally not be accessible to the projection unit 5 which has a fixed position. In FIG. 6, surfaces 12-1, 12-2 and 12-3 are completely inaccessible to the fixed projection unit 5-1. The moveable projection unit 5-2 may be moved so as to be positioned relative to 12-1, 12-2 and 12-3 so that the projector 3 may project onto each projection surface 12-1, 12-2 and 12-3. The enhanced motion of the moveable projection unit 5-2 is realized by the use of the mount 52 coupled to the rail system 51. In this embodiment, the rail system 51 includes a first rail 51-1 and a second rail 51-2. Accordingly, the rail system 51 provides for the single projection unit 5-2 to service the large rectangular setting 2, such as a store or a factory.

FIG. 7 depicts an embodiment where the projection system 10 is used in a supermarket or store. In this embodiment, the system 10 may provide information and interactive capabilities to many customers at many different locations. Preferably, the movable projection unit 5-2 is repositioned (under computer control) throughout the store and projects onto shelves or surfaces 12 with which the customers are interested. The fixed position projection unit 5-1 may be used in concert with the movable projection unit 5-2, and project interactive substantially undistorted images 11 to surfaces 12 that are in the line of sight and unoccluded at the time of projection. FIG. 7 illustrates the flexibility of the moveable unit 5-2 over the fixed or static position projection unit 5-1.

By enhancing the positioning controls over the projection unit 5, optimal surfaces 12 and projection angles can be achieved for each task. Positioning can be accomplished by a variety of kinematic mechanisms, based on the needs of the application. Consider the positioning system 50 depicted in FIG. 4, where the rail system 51 is used. In this example, the single rail 51-1 provides one degree of freedom for translational movement of the projection unit 5. This type of positioning system 50 may be both adequate and powerful for servicing an aisle in a retail store. In this embodiment, one projection unit 5 could move along the single rail 51-1 achieving many positions and servicing a number of surfaces 12. In addition, the projection unit 5 could project on the same surface 12 from a plurality of projection angles, allowing the system 10 to compensate for occlusion by selecting a surface 12 and projection angle that minimizes existing occlusion. The projection unit 5 may be moved on the single rail 51-1 either manually or by a mechanized system controlled by the positioning controller 53.

In one embodiment, in addition to the X-Y positioning depicted in FIGS. 5-9, the positioning system 50 provides translational movement capabilities for positioning in the Z axis. As an example, refer to FIG. 4, where the mount 52 includes the positioning device 57, which includes a telescoping mount. In this embodiment, the telescoping mount provides a range of translational movement in the Z direction. Other non-limiting examples of positioning equipment include use of a scissor lift and an articulating arm. Adding a third degree of freedom to translational movement of the positioning system 50 affords an even greater range of projection angles that can be achieved, thus enhancing ability to overcome or ameliorate the effects of occlusion.

The positioning system 50 may be used to control various aspects of the substantially undistorted image 11. For example, the resolution of the substantially undistorted image 11 can be controlled by techniques such as moving the projection unit 5 close to the projection surface 12 to provide for high resolution. Alternatively, large areas of low resolution may be achieved by positioning the projection unit 5 some distance away from the projection surface 12. Such techniques offer further advantages over fixed systems.

A variety of kinematic devices may be used to position the projection unit 5. The variety increases the choices of surfaces on which the substantially undistorted image 11 may be projected, and the projection angles that can be achieved. Kinematic systems that may be suitable for use in the positioning system 50 may be specially developed for an application, or found in other arts. For example, some kinematic systems employed in robotics technologies are suited for use as a positioning system 50. That is, the projection unit 5 could be positioned on a robotic system as an end-effector, providing for positioning such that projection of the distorted image 16 is steered to the desired location.

In addition, mobile robot technology is commonly available that can carry and position the projection unit 5 to accomplish a wide range of activities. For example, a mobile unit carrying the projection unit 5 could be dispatched to locations where interaction is desired. One example includes a remotely controlled ground based vehicle. A remotely guided aerial vehicle, such as a small helicopter, may also be used to position the projection unit 5. The mobile unit may be outfitted with positioning equipment as necessary, such as a global positioning system (GPS) sensor, or other receiver.

The mechanism for moving the projection unit 5 need not be motorized, or computer controlled. For example, the user 1 or operator could manually position the projection unit 5 for subsequent use in the configuration so provided. One example of the mechanism for manual positioning is an articulating arm, similar to that used for positioning lighting and X-Ray equipment used in the dental industry. Manual placement may not be preferred, as it is generally considered important to include correction for oblique projection distortion. However, in some embodiments, the positioning mechanism 50 used for manual placement offers a variety of preset positions, to which the system 10 has been calibrated.

The effects of distortion may be overcome by calibration of the projection system 10. Calibration may be automated or manually performed. Preferably, calibration considers an adequate quantity of positions such that the system 10, once in operation, provides users 1 with substantially undistorted images 11, or images 11 that are characterized by other desired properties, such as being sharply in focus. Preferably, the positioning controller 53 stores calibration information in the storage 23. The positioning controller 53 then makes use of the calibration information to ensure substantially undistorted images 11 during operation. Calibration is discussed in greater depth further herein.

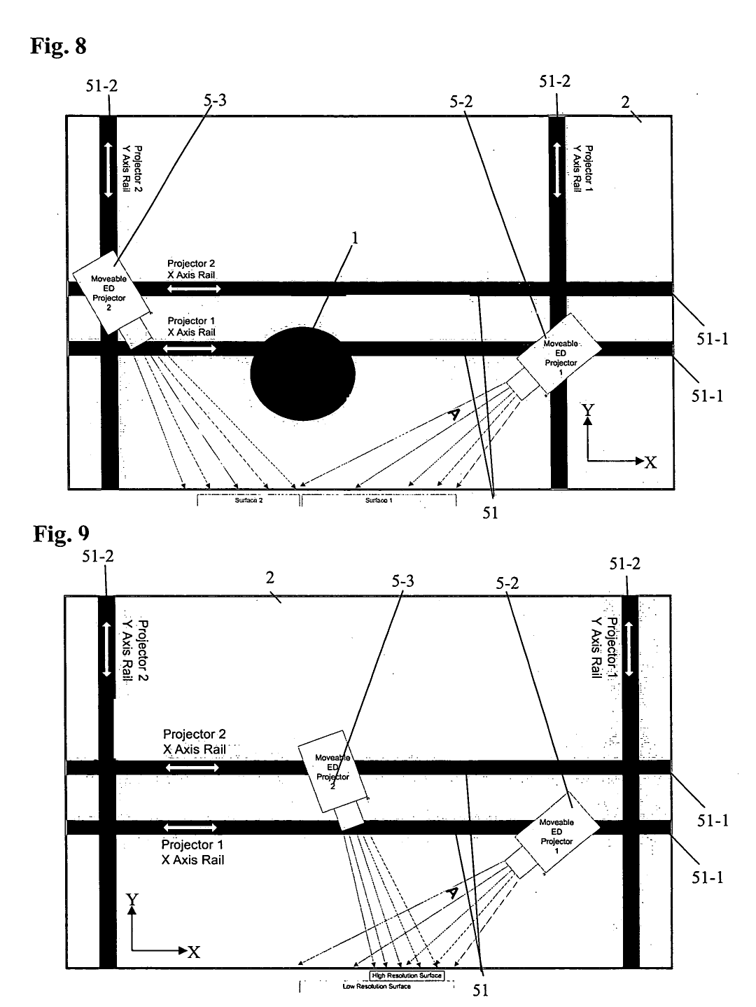

The ability to coordinate several projection units 5 can provide further value in many application settings 2. For example, projection of distorted images 16 can be combined to effectively produce a larger display and/or provide increased resolution. An example is provided in FIG. 8, which depicts two projection units 5-2, 5-3 which are coordinated to provide the single substantially undistorted image 11 or interactive region 13 by projecting parts of the interaction. Further, FIG. 8 depicts an embodiment where operation of the projection units 5-2, 5-3 is coordinated to avoid occlusion by the user 1. In other embodiments, as depicted in FIG. 9, one projection unit 5-2 provides a low resolution background image and the second projection unit 5-3 provides a steerable high resolution image over the low resolution background. More specifically, one example of the substantially undistorted image 11 which has a combination of low and high resolution components involves the production of a low resolution map with a steerable high resolution (“zoomed in”) projection of what is in a specific area of the map.

Further, in some situations it is desirable to dynamically position multiple projections in proximity to each other. For example, in some settings 2, the user 1 may want to view several different images on surface 12 which depicts multidimensional aspects of an object. For example, the user 1 may wish to view multidimensional aspects of an engineering object side-by-side with such other aspects as a solid geometric model, a finite element model and a few dynamic performance graphs of related parameters. In this way, the user 1 can see correlations between the various dimensions of the engineering object that are normally hard to observe.

Note that the system mount 54 depicted in FIGS. 8-9 involves a rail system 51 having multiple rails 51-1, 51-2. The rails include an X-component 51-1, and a Y-component 51-2. Other equipment as discussed herein may be appropriately combined, repeated or modified to provide for the desired results. For example, each rail 51-1, 51-2 may ride in tracks (not shown) disposed along the ends of each rail 51-1, 51-2, thus providing for translational movement along the X or Y axis to position the projection unit 5. Further, the system mount 54 may also include pan and tilt functions in addition to the pan and tilt functions of the projection unit 5 to enhance orientation of the projection unit 5. Using this type of system mount 54, the positioning system 50 is equipped to position and orient the projection unit 5 anywhere within the travel area of the system mount 54.

The incorporation of the positioning system 50 provides for capabilities not achievable in the prior art. For example, projection units 5 can be dynamically dispatched and used in areas where needed. This provides for an increased system utilization, while minimizing the overall number of projection units 5 needed to service setting 2. Further, several projection units 5 can be dispatched to the requested location and coordinated to provide special capabilities afforded only by use of multiple projection units 5. For example, four projection units 5 could work together to provide a small but very high resolution display image, a large but low resolution display, or a mixture of low and high resolution images on a given surface 12. Exemplary applications that could take advantage of such a system include the engineering review sessions described above, and a military review where distorted images 16 are projected (from above or the sides) onto complex models of terrain maps.

The ability to move the projection unit 5 enables very complex interaction capabilities between projection units 5, thus providing for different quality displays at many more locations than may be achieved using fixed units 5. For example, in a large interactive space, several projection units 5 may be coordinated to provide the user 1, with information and afford interaction while avoiding occlusion. For example, a large translucent display wall may be used in combination with a set of moveable projection units. In this embodiment, the wall provides a back projection surface where substantially undistorted images 11 of varying resolution are displayed. A result is that the set of projection units can be directed to project on any location on the wall and coordinated so as to combine substantially undistorted images 11 and to create a large interaction region 13. In some situations it is preferable that the interaction region 13 and image area do not appears as a combination of projections from the multiple projection units 5, but appear as one display that further can be dynamically moved to different places over the large surface 12.

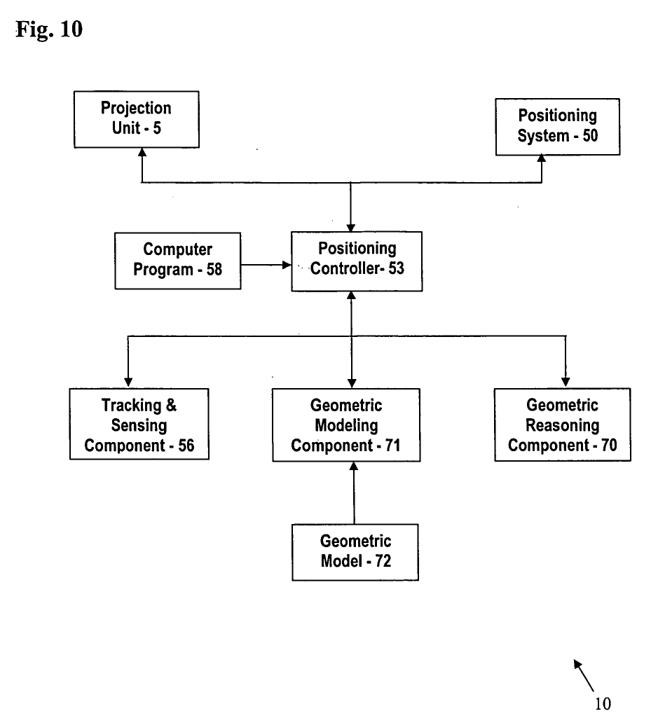

FIG. 10 outlines exemplary components of the projection system 10, and depicts one embodiment for communication between the components and use of the system 10. The positioning controller 53 that controls the projection unit 5 positions the projection unit 5 using the positioning system 50. Preferably, the positioning controller 53 is loaded with a program 58 (depicted in FIG. 4) which is stored in the storage device 23. The tracking and sensing component 56 tracks users 1 in the operating area and determines if assistance is needed. One example of tracking and sensing equipment 56 is an array of push buttons placed throughout the space, and available for the user 1 to signify a request for assistance. More complex equipment may be used, such as equipment for tracking the position of users in the store and reasoning whether they need any assistance. Examples might include use of wireless transmitters. The tracking and sensing component 56 relays location coordinates of the user 1 that needs assistance to the positioning controller 53. The positioning controller 53 operates a geometric reasoning component 70 to determine the surface 12 to be used for presenting the image 11. The geometric reasoning component 70 refers to a geometric model 72 of the current configuration. Preferably, the geometric model 72 was previously created and stored using the geometric modeling component 71. In some embodiments, the geometric model 72 is created and stored during system 10 calibration. In some other embodiments, the geometric model 72 is produced by the geometric reasoning component 70 by interpolation or other manipulations of stored or received data. The geometric reasoning component 70 provides information about available surfaces 12 to the controller 53. Accordingly, the positioning controller 53 commands the positioning system 50 to move to the projection unit 5 to the appropriate position. Preferably, the positioning controller 53 initiates operation of the display controller 20.

In other embodiments, the projection unit 5 is moved to predefined positions. Preferably, for these embodiments, the positioning controller 53 does not rely on the tracking and sensing component 56, as the system 10 is statically positioned.

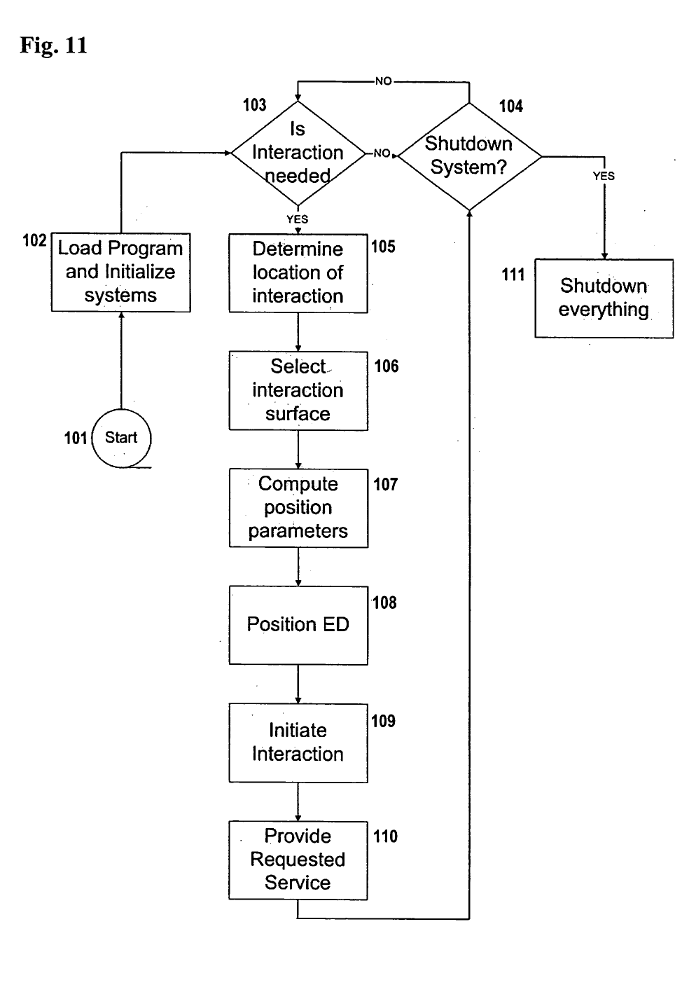

FIG. 11 illustrates one embodiment of the control flow for the program 58 governing operation of the positioning controller 53. In the exemplary embodiment, program flow begins at the start node 101. In a second step 102, the program 58 loads into memory, and initiates all systems. In a third step 103, the program 58 tests for a service request. If the test provides a result that service is not needed, then the program 58 proceeds to step 104 and tests whether the system 10 should be shut down. One example of a shutdown test may include interrogation of a time table for operation. In step 111, the system 10 performs a shutdown routine. However, if the test in step 103 indicates interaction is requested, the program 58 determines the location of the requested interaction in step 105. Once the location has been determined, the surface 12 is selected in step 106, preferably from a data table stored in the storage device 23. Subsequently, position parameters 72 for the particular surface 12 are determined in step 107. In step 108, the projection unit 5 is positioned. Once the positioning step 108 is complete, interaction is initiated in step 109. The program 58 then provides the user 1 with the requested service in step 110.

It should be noted that the foregoing description of program flow is an overview, and not limiting of the program 58. For example, in some instances, such as embodiments where the system 10 is used in a promotional context (i.e., in a retail environment), a portion of the image 11 may be moving. In this embodiment, the positioning of step 108 is ongoing for a first projection unit 5, while a second projection unit 5 provides for interaction as described in step 109. In some embodiments, step 109 may be omitted. As an example, the system 10 may be deployed in a production environment and simply provide a user 1 with production line status when requested.

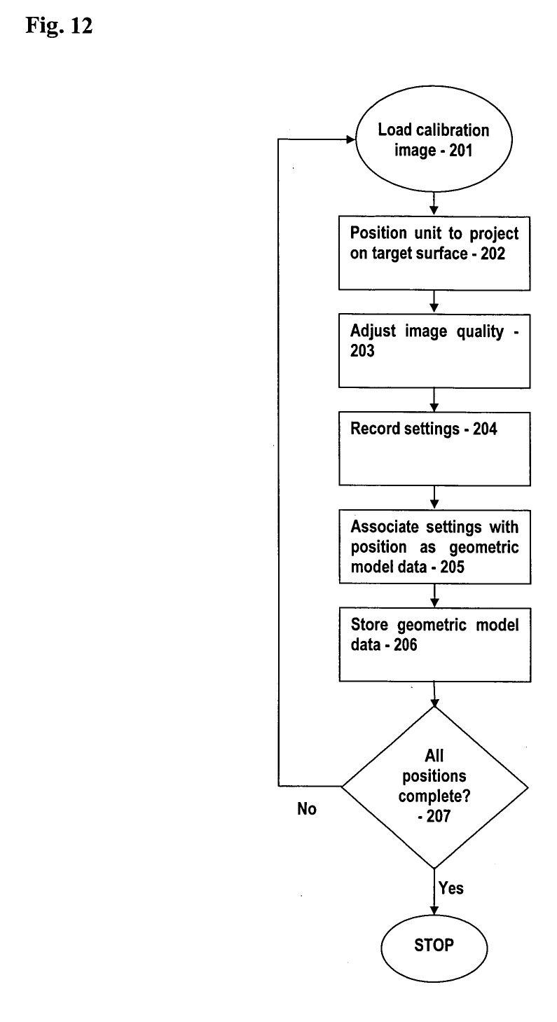

One example of a calibration sequence is depicted in FIG. 12. In FIG. 12, a system operator loads a calibration image into the projection unit 5 in step 201. The projection unit 5 is then manually or automatically moved to a position for projecting onto a target surface 12 in step 202. The operator may then manually or automatically adjust the quality of the image (such as focus, or alignment) by manipulating settings of the projection unit 5. Manipulation of settings is completed in step 204. Once the image 11 having the desired level of quality is achieved, the settings are recorded in step 204. In step 205, the settings are associated with the position and the target surface 12 as geometric model data 72. The geometric model data 72 is stored for reference during operation. In step 207, the operator determines if the calibration sequence is complete, and acts accordingly. System calibration typically provides for reduced processing and quicker response of the system 10 during operation. In other embodiments, calibration is completed automatically.

In one embodiment, calibration of the positioning system 50 is performed by operation of the positioning system controller 53, using at least one reference point. In this embodiment, the positioning system 50 is set to the reference point, which may be referred to as a “home” position. When the positioning system is set to the reference point, an offset value is determined. The offset value is indicative of a difference between actual positioning of the positioning system 50, and the indicated position. The offset value is used to correct for positioning error. Multiple reference points may be used. In other embodiments, offset values are determined periodically by manual calculation, and result in manual adjustments to the positioning system 50.

In one embodiment where automatic calibration is performed, the system 10 contains information regarding the setting 2. Setting information may include position of a surface 12 relative to a starting point (such as a “home” location for the projection unit 5). Setting information is preferably stored in storage 23. In this embodiment, the system 10 preferably makes use of various geometric data to determine calibration corrections. This type of system calibration provides advantages in that the system 10 can determine corrections for providing satisfactory quality images 11 during operation. Making such determinations during operation provides for enhanced flexibility in selection of positions for projections.

Further aspects of calibration include calibrating the interaction recognition system 4. Typically, calibration of the interaction recognition system 4 involves providing for efficient operation and/or cooperation with the projection unit 5. One skilled in the art will recognize that a variety of techniques may be used for such calibrations. One example includes ensuring registration of a projected image 11 with user interactions sensed by a camera. Other embodiments contemplate, among other things, aspects of the equipment used in the interaction recognition system 4 (e.g., adjusting microphone sensitivity for sensing voice where the image 11 is projected onto a variety of surfaces 12 having varying distances from the microphone).

One skilled in the art will recognize that the invention disclosed herein is not limited to the exemplary embodiments disclosed herein. That is, one skilled in the art may recognize numerous variations in equipment, techniques for operation, and settings for use. Therefore, it is considered that the teachings herein are only illustrative of the invention, as set forth in the appended claims.

1. A positioning system comprising,
at least one mount for mounting a projection unit, the projection unit comprised of at least a projector for projecting a distorted image; wherein the at least one mount is coupled to a mechanism for providing translational movement and rotational movement for adjusting one of a position and an orientation of the projection unit to produce from the distorted image a substantially undistorted image on a surface.

2. The positioning system as in claim 1, wherein the projection unit comprises a redirection device.

3. The positioning system as in claim 2, wherein the redirection device comprises a mirror.

4. The positioning system as in claim 2, wherein the redirection device comprises at least one of a lens, an optical fiber and a prism.

5. The positioning system as in claim 1, wherein the at least one projector is coupled to a controller for generating the distorted image

6. The positioning system as in claim 5, wherein the controller comprises one of a remote controller, a controller integrated with the projection unit and a controller mounted with the projection unit.

7. The positioning system as in claim 1, wherein one of the distorted image and the substantially undistorted image comprise an interactive region for a user interaction.

8. The positioning system as in claim 7, wherein the user interaction comprises an instruction for operation of external equipment.

9. The positioning system as in claim 1, wherein one of the mount and at least another mount is adapted for mounting an interaction recognition system.

10. The positioning system as in claim 1, wherein the projection unit comprises an interaction recognition system.

11. The positioning system as in claim 9, wherein the interaction recognition system comprises apparatus for detecting a user interaction.

12. The positioning system as in claim 9, wherein the interaction recognition system comprises at least one camera.

13. The positioning system as in claim 9, wherein the interaction recognition system comprises a voice recognition system.

14. The positioning system as in claim 1, wherein the mechanism comprises at least one of a rotational mechanism and a translational mechanism.

15. The positioning system as in claim 1, wherein the mechanism is comprised of at least one of a telescoping mount, a scissors lift, an articulating arm, a kinematic device and a rail system.

16. The positioning system as in claim 1, wherein the mechanism is adapted for attaching to a fixed support.

17. The positioning system as in claim 1, comprising a positioning controller for controlling the position of the at least one projector.

18. The positioning system as in claim 17, wherein the positioning controller comprises a source of geometric model information.

19. The positioning system as in claim 1, comprising tracking and sensing equipment for identifying a position for the at least one projector.

20. The positioning system as in claim 1, wherein the system is adapted for positioning the at least one projector with two degrees of freedom.

21. The positioning system as in claim 1, wherein the system is adapted for positioning the at least one projector with three degrees of freedom.

22. The positioning system as in claim 1, wherein the system is adapted for orienting the at least one projector with two degrees of freedom.

23. The positioning system as in claim 1, wherein the system is adapted for orienting the at least one projector with three degrees of freedom.

24. A method for providing a substantially undistorted image upon a surface, the method comprising:
sensing a request from a user for a projection at a location;
selecting a projection unit comprised of at least a projector for projecting a distorted image; and,
moving the at least one projector by operating a mechanism comprising the at least one projector mounted on a moveable portion of the mechanism, wherein the mechanism is adapted for providing translational movement and rotational movement of the at least one projector to provide the substantially undistorted image upon the surface at the location.

25. The method as in claim 24, wherein sensing comprises identifying a request from at least one of equipment for automatically entering the request and equipment for manually entering the request.

26. The method as in claim 24, wherein operating the mechanism comprises one of manually operating the mechanism and automatically operating the mechanism.

27. The method as in claim 24, wherein positioning comprises locating the projection unit to provide for an image substantially free from occlusion.

28. The method as in claim 24, comprising coordinating position of the at least one projector with a position of at least an interaction recognition system.

29. The method as in claim 24, comprising coordinating the position of the at least one projector with a position of at least another projector.

30. The method as in claim 29, wherein the projection unit produces a first portion of the distorted image and the at least another projection unit produces another portion of the distorted image.

31. A method for calibrating a positioning system for a projection unit comprised of at least a projector adapted for projecting a distorted image, the positioning system for providing a substantially undistorted image to a user, the method comprising:
loading a calibration image into the at least one projector;
moving the at least one projector to a location to project the calibration image upon a target surface;
adjusting settings of the at least one projector to produce a calibration image that is substantially undistorted upon the target surface;
recording the settings for the at least one projector at the location;
associating the settings with the target surface to produce a set of geometric model data;
storing the set of geometric model data; and,
repeating the loading, moving, adjusting, recording, associating and storing for a plurality of positions of the at least one projector.

32. A method to provide a substantially undistorted image upon a surface at a location, the method comprising:
providing a projection unit coupled to a positioning system, the projection unit comprised of at least a projector for providing an image;
loading setting layout information into a positioning controller for operating the positioning system;
positioning the at least one projector at a location by referring to the setting layout information;
referring to the setting layout information to determine projection settings for the at least one projector; and,
adjusting the settings of the at least one projector to the projection settings to produce the image upon the surface.

33. A method for adjusting at least one input setting of an interaction recognition system coupled to a positioning system, the method comprising:
providing a positioning system comprising at least one mount adapted for mounting a projection unit and at least one other mount for positioning the interaction recognition system, wherein the interaction recognition system provides for a user input in response to an image projected by the projection unit;
loading area layout information into a positioning controller for operating the positioning system;
positioning the interaction recognition system at a location by referring to the area layout information;
referring to the area layout information to optimize the at least one input setting for the interaction recognition system; and,
adjusting the at least one input setting of the interaction recognition system.

34. A computer program stored on a computer readable media, the program comprising instructions for positioning a projection unit to produce a substantially undistorted image, the instructions for:
sensing a request from a user for production of an image at a location;
positioning the projection unit to provide the substantially undistorted image upon a surface at the location, wherein positioning comprises referring to a stored geometric model for the location to produce the substantially undistorted image in accordance with the geometric model.

35. A positioning system, comprising:
mounting means for mounting a projection means comprised of at least an image projecting means for projecting a distorted image; wherein the mounting means is coupled to positioning means for providing translational movement and rotational movement of the projection means to produce a substantially undistorted image from the distorted image.

36. The positioning system as in claim 35, wherein the positioning means comprises means for moving the image projecting means through a range of movement comprising between two degrees of freedom and six degrees of freedom.

37. A projection system, comprising:
at least one projection unit comprised of at least a projector for projecting a distorted image, the at least one projector mounted to at least one mount that is coupled to a mechanism providing translational movement and rotational movement for positioning the at least one projector to produce a substantially undistorted image from the distorted image.

38. The projection system as in claim 37, wherein the projection unit comprises a controller for generating the distorted image coupled to the at least one projector.

39. The projection system as in claim 37, wherein one of the substantially undistorted image and the distorted image comprises an interactive region.

40. An image projection system comprising a controller coupled to a positioning apparatus for positioning a projection unit in three-dimensional space, the system for producing a substantially undistorted image at a specified location, the controller being responsive to stored geometric model for the location to cause the projection unit to provide the substantially undistorted image.
